(19) United States
(12) Patent Application Publication
(10) Pub. No.: US 2005/0017724 A1
(43) Pub. Date: Jan. 27, 2005

(54) Waste-power KV simulator and method for hybrid/DIS ignition

(75) Inventor: Kenneth A. McQueeney, Los Gatos, CA (US)

Correspondence Address: MCDERMOTT WILL & EMERY LLP, 600 13TH STREET, N.W., WASHINGTON, DC, 20005-3096, US

(73) Assignee: SNAP-ON INCORPORATED

(21) Appl. No.: 10/924,969

(22) Filed: Aug. 25, 2004

Related U.S. Application Data
(63) Continuation-in-part of application No. 10/804,222, filed on Mar. 19, 2004.
(60) Provisional application No. 60/456,233, filed on Mar. 21, 2003.

(51) Int. Cl. F02P 17/00

(52) U.S. Cl. 324/380

(57) ABSTRACT

An apparatus for testing a waste-power ignition coil includes an igniter simulator having a switching device, a high voltage switch, and a spark gap connected to the high voltage switch. The switching device is electrically connected to an output of the primary side of the waste-power ignition coil and a triggering element for changing a state of the first switching device at a predetermined interval. The high voltage switch includes a first pair of contacts electrically connected to one of a positive going and negative going outputs of a secondary winding of the waste-power ignition coil, and a second pair of contacts electrically connected to another of a positive going and negative going outputs of the secondary winding of the waste-power ignition coil. The high voltage switch acts substantially synchronously with the switching device to connect a respective one of the positive going and negative going outputs of the secondary winding of the waste-power ignition coil with respect to the adjustable spark gap, to simulate a waste-stroke phase.

### CROSS REFERENCE TO RELATED APPLICATIONS

This application is a Continuation-In-Part of U.S. application Ser. No. 10/804,222, filed on Mar. 19, 2004, which claims priority to U.S. Provisional Application No. 60/456,233, filed Mar. 21, 2003, both incorporated herein by reference in their entirety.

### TECHNICAL FIELD

The disclosure is directed to the field of ignition coils. It is more specifically directed to simulation of an engine environment for the purpose of testing the operation of distributorless ignition coils, particularly of the direct ignition system (DIS) and hybrid DIS variety.

### BACKGROUND ART

Ignition coils are commonly used to boost a low voltage supply voltage to the very high voltage level that is necessary to ignite a spark. As is well known, the boosted voltage is usually delivered to a spark plug, typically installed in a combustion engine. The spark ignites fuel, causing increased pressure in the cylinder in which the spark plug is mounted, resulting in movement of the piston within the cylinder.

The ignition coil itself is, essentially, a transformer having a very large turn ratio, typically between 1:50 to 1:100, between a primary winding and a secondary winding, which transforms a low voltage in the primary winding provided by the sudden interruption in primary current to a high voltage charge in the secondary winding. In older ignition systems, the ignition coil is connected to the center or coil terminal of a distributor cap by an insulated wire. High voltage from the ignition coil is distributed from the coil terminal to side or spark plug terminals of the distributor cap by means of a rotor. As the tip of the rotor spins in the cap past a series of contacts (one contact per cylinder), a high-voltage pulse from the coil arcs across the small gap between the rotor and the contact and continues down the spark-plug wire to the spark plug on the appropriate cylinder, thus distributing the spark to each spark plug terminal at a predetermined timing.

More recently, ignition systems have evolved to “distributorless” ignition systems having one coil per cylinder (e.g., conventional coil-on-plug (COP)) or one coil per cylinder pair (e.g., a direct ignition system (DIS) or Hybrid). These distributorless ignition systems are conventional and widely known. Distributorless ignition systems, as the name implies, do not utilize distributor caps and rotor and, instead, incorporate an ignition coil over each plug (or plug pair) or an ignition coil near each plug (coil near plug or CNP)(or plug pair). The ignition coil generates the high voltage and supplies it only to the single spark plug (e.g., COP) or spark plug pair (e.g., DIS or Hybrid) with which it is associated. Coil-on-plug (COP) ignitions generally comprise a spark coil integrally mounted on a spark plug, which protrudes into and is mounted in an engine cylinder and terminates in a spark gap. The spark coil conducts transformed, high voltage direct current to the spark plug using internal connections. The coil receives low voltage direct current via a wiring harness that has a distal end coupled to a primary coil of the coil and a proximal end coupled to a battery.

Some distributorless ignition systems (e.g., Hybrid) are configured so that one of the two plugs in the pair is buried or otherwise inaccessible (e.g., one plug is a COP), whereas other distributorless ignition systems (e.g., DIS) are configured so that both plugs in the pair are accessible. For example, in the Hybrid ignition system, the ignition coil may be connected to one spark plug by a conventional ignition wire and to the other companion spark plug by means of a direct connection (e.g., a COP connection, such as a rigid extension or bus protruding from the bottom of the ignition coil to the spark plug). Thus configured, the DIS and Hybrid simultaneously generate and output two different high voltage signals and associated electric near fields. As known to those of ordinary skill in the art, it is with these electric near fields that an appropriately configured sensor, such as but not limited to that shown in U.S. Pat. No. 6,396,277, the content of which is incorporated herein by reference, may be used to develop waveforms of the ignition cycle to aid in detection of and diagnosis of ignition system anomalies.

However, before a DIS or Hybrid ignition coil is installed in an engine, it must be tested to ensure proper operation. Otherwise, a detected fault within the ignition system could be the ignition coil itself and not the elements of the system that are being tested. Currently, the only way to test such an ignition coil is to install the ignition coil on a properly running engine having duly tested and certified ignition system components. The ignition coil is installed in the engine and the engine is operated to conduct the test of the ignition coil. Outputs of the coil are observed to determine if the proper voltage levels are being output by the ignition coil. Thus, the engine is presently necessary to test the operation of the ignition coil under operating conditions, a limitation which renders the testing cumbersome and inconvenient. A need therefore exists for an improved testing method and apparatus which eliminates the need for an engine to conduct the ignition coil testing.

### SUMMARY OF THE DISCLOSURE

This disclosure relates to a system for simulating the operation of a distributorless ignition coil, particularly of DIS of Hybrid (e.g., “waste-spark” or “waste-power”) ignition coils, to facilitate testing of the ignition coil. The system simulates the operating parameters of an ignition coil without the need to use an actual engine.

In one aspect, a testing apparatus for testing a waste-power ignition coil includes an igniter simulator having a switch device, a high voltage switch, and a spark gap connected to the high voltage switch. The switching device is electrically connected to an output of the primary side of the waste-power ignition coil and a triggering means for changing a state of the first switching device at a predetermined interval. The high voltage switch includes a first pair of contacts electrically connected to one of a positive going and negative going output of a secondary winding of the waste-power ignition coil, and a second pair of contacts electrically connected to another of a positive going and negative going output of the secondary winding of the waste-power ignition coil.

In operation, the high voltage switch acts intermittently, at a pre-selected interval, to connect the output of the waste-power ignition coil primary coil to the adjustable spark gap. The high voltage switch also acts substantially synchronously with the switching device to connect a respective one of the positive going and negative going output of the secondary winding of the waste-power ignition coil with the adjustable spark gap to simulate a waste-stroke phase.

Additional advantages will become readily apparent to those skilled in the art from the following detailed description, wherein only an exemplary embodiment of the present invention is shown and described, simply by way of illustration of the best mode contemplated for carrying out the present invention. As will be realized, the disclosure is capable of other and different embodiments, and its several details are capable of modifications in various obvious respects, all without departing from the invention. Accordingly, the drawings and description are to be regarded as illustrative in nature, and not as restrictive.

### BRIEF DESCRIPTION OF THE DRAWINGS

FIG. 1 is a block diagram of a simulation system for testing an ignition coil;

FIG. 2 is a schematic diagram of one example of a simulation system of FIG. 1 in accord with the present concepts;

FIG. 3 is a waveform diagram showing detected voltages at each of the spark plugs associated with the system of FIG. 1; and

FIG. 4 illustrates a diagnostic system for detecting and reporting on the voltages within the simulation system in accord with the present concepts.

The figures referred to herein are examples provided and drawn for clarity of illustration and are not intended to be limiting in any way. The figures are not necessarily drawn to scale and are not necessarily inclusive of every feature or aspect of the objects or concepts featured therein. Elements having the same reference numerals refer to elements having similar structure and function.

### DETAILED DESCRIPTION OF THE PREFERRED EMBODIMENTS

Embodiments described herein or otherwise in accord with the concepts presented herein may include or be utilized with any appropriate voltage source, such as a battery, an alternator and the like, providing any appropriate voltage such as, but not limited to, about 9 Volts, about 12 Volts, about 42 Volts and the like.

During normal operation of an internal combustion engine having a DIS or Hybrid ignition system, each side of the ignition coil secondary winding is connected to a separate spark plug of a pair of plugs. As is known, the cylinders associated with the pair of spark plugs operate in a reciprocal manner. When the cylinder containing the first plug is on its compression stroke or power stroke, the other spark plug is on its exhaust stroke or waste stroke. Hence, these types of DIS and Hybrid ignition coils, and related coils and assemblies, may be generally referred to as “waste spark” or “waste-power” ignition coils or ignition systems. Conversely, when the cylinder containing the first plug is on its exhaust stroke, the other spark plug is on its power stroke.

In a normally performing engine, the power stroke firing line (an event wherein the delivery of the secondary voltage to the spark plug gap causes ionization across the spark plug gap and arcing across the electrodes to produce a spark to initiate combustion in the fuel-laden, pressurized cylinder) is in the order of approximately 6-12 KVp (peak KV). The waste-stroke or exhaust stroke firing line in the companion cylinder is typically on the order of about 2-4 KVp.

The ignition waveforms are conveniently sensed using a capacitive or inductive signal detector or detectors, such as the signal detector described in U.S. Pat. No. 6,396,277, the entire content of which is incorporated herein by reference. The selected signal detector may comprise, for example, a conventional capacitive adapter or capacitance coupled adapter such as, but not limited to, Snap-On® COP-1 through COP-9 adapters (EETM306A03 through EETM306A13), Vantage® kV Module CIC adapters, Vantage® kV clips, Modis® kV clips, Snap-On® spring clip, Snap-On® universal clip, Snap-One magnetic mount adapter, DIS tester HV wire clip, Bosch® HV wire clip, Snap-On® flags, or Snap-On® hybrid adapters. These signal detectors may be connected to any conventional engine analyzer, lab scope, ignition scope, or display, such as but not limited to a Snap-On® Vantage®/KV Module (EETM306A) or Snap-On® MODIS® module, using an appropriately configured signal output device or cable (e.g., a Snap-On® cable EETM306A01 or 6-03422A, Rev. D, for the above diagnostic devices).

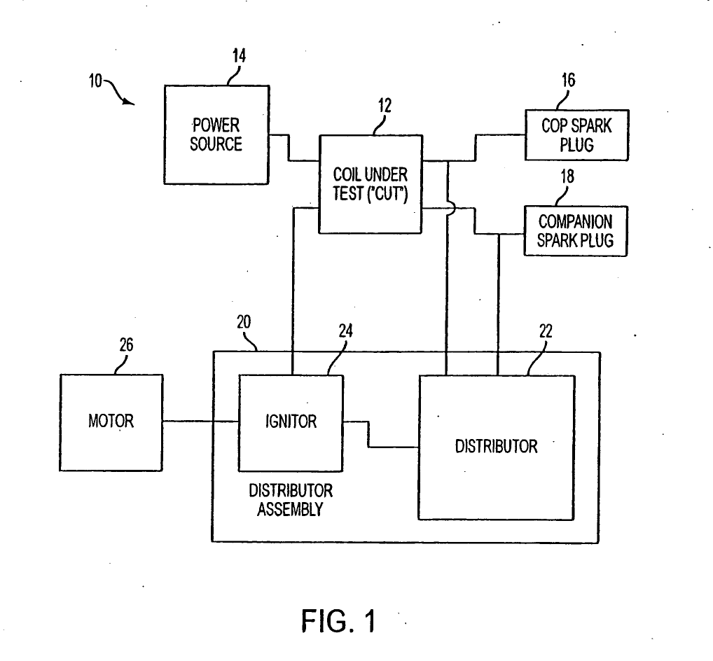

FIG. 1 is a block diagram of a testing apparatus or simulation system 10 which presents, to the ignition coil under test (“CUT”) 12, the relevant characteristics that will normally be experienced by the ignition coil under actual operating conditions. FIG. 1 shows a simulation system 10 in accord with the present concepts, wherein an ignition coil under test (“CUT”) 12 is coupled to power source 14 and is coupled to adjustable gap spark plugs 16, 18 by output lines 62, 58, respectively. A high voltage switch, such as a distributor assembly 20, including a distributor 22 and an ignition switch 24, is also shown. Electrical connectors connect the distributor 22 to the CUT 12 output lines 62, 58. The distributor 22 and ignition switch 24 are optionally connected to and driven by a motor 26 (powered by a power source (not shown)), as further described below.

Power source 14 may include a +14.0 VDC source (or other pre-selected voltage appropriate to the particular ignition coil under test), which may be a car battery under charge, a high power DC power supply, a battery charger, or other fixed or variable DC power source. It is preferred that the power source 14 be limited to a voltage drop of less than about 0.15 VDC from a pre-selected operating voltage during operation of the simulation system 10.

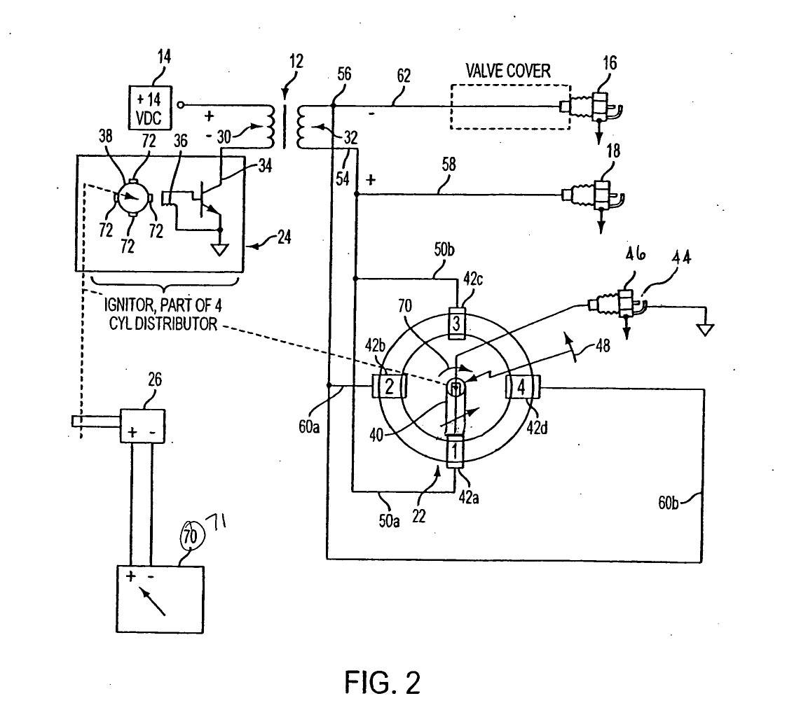

As shown in greater detail in FIG. 2, spark plug 16 is disposed in a conventional coil-over-plug (“COP”) configuration, wherein the spark plug is rendered inaccessible due to a valve cover, and is connected to a negative going output 62 of the CUT 12 secondary winding 32. Spark plug 18 (companion spark plug), which is accessible, is connected to the positive going output 58 of the secondary winding 32.

The operation of the simulation system 10 will be described with reference to FIG. 2. The positive terminal of power source 14 is connected to the positive side of the primary winding 30 of the CUT 12. The negative side or output side of the primary winding 30 is connected to a switching device, such as a field effect transistor (FET) 34, included within the ignition switch 24. An inductor 36 is connected to the control terminal of the switch 34 and receives an input from an actuator 38.

In the illustrated example, the actuator 38 is a 4-pole 72 magnetic gear wheel disposed about an output shaft of DC motor 26 so as to rotate or move with respect to the stationary inductor 36. The rotating magnetic poles 72 induce current flow in inductor 36, which provides a voltage to power the FET 34, in a manner that can be readily appreciated by one of ordinary skill in the art. When the switch (e.g., FET) 34 is closed, current flows into the primary winding 30, which charges the inductance of the primary winding 30. When the switch 34 is then subsequently opened, a sudden increase in voltage occurs across the primary winding 30, which results in a stepped up voltage being output from secondary winding 32.

Other conventional means may be used to intermittently and periodically connect the output side of the primary winding 30 to ground including, but not limited to, a solid-state system which omits the motor 26 and magnetic gear wheel, and a mechanical system which omits the FET in favor of a mechanical switch. Actuator 38 comprises any mechanical, electrical, and electromechanical means by which a switch may be biased into and out of a state wherein the output side of the primary winding 30 is connected to ground.

The distributor 22 may include, in one aspect, a four cylinder, external coil type of distributor. Since only one ignition coil 12 is tested at a time, this configuration provides the necessary testing conditions, regardless of the number of cylinders in the engine in which the ignition coil will be used. However, the present concepts include distributors 22 adapted for use with a different number of cylinders.

The distributor 22 includes a rotor 40 and contacts 42a-42d that are directly contacted by the rotor 40. In this manner, the distributor 22 acts as a high voltage four position rotary switch. Although any device acting as a high voltage switch is acceptable for use with the testing system, one method of forming the high voltage switch includes inverting a distributor cap 22 and filling the distributor cap with an epoxy, or other similarly malleable or fluid non-conductive material, to a level slightly above the four contacts 42a-d that are routed to spark plugs 16, 18 after installation of a temporary dam to contain the epoxy between the contacts and the adjacent inside walls of the cap. Using a suitable jig, the epoxy is machined to expose all four metal contacts 42a-d. The resulting cylindrical surface then becomes a wall upon which a metal spring contact affixed to the end of the rotor 40 can ride, thereby providing the high voltage four position rotary switch.

In place of the modified distributor 22, other conventional high voltage switches may also be provided and may comprise any conventional high voltage rotary switch(es) or high voltage switches arranged for sequential operation. To obtain an actual peak waste spark firing line, the high voltage switch, for example via the center contact 48 of the rotor 40, is connected to a spark gap 46. The spark gap 46 may optionally be adjusted by relative movement of an adjustable point 44 to vary the waste stroke spark voltage, described in more detail below.

As indicated in FIG. 2, contact 42a represents position 1 of the distributor, contact 42b represents position 2, contact 42c represents position 3 and contact 42d represents position 4. Contacts 42a and 42c, representing positions 1 and 3, respectively, are coupled together through spark plug wires 50a and 50b and then to side 54 of the secondary winding 32, which side receives the positive-going output voltage of the secondary winding 32. This side 54 is also connected to companion spark plug 18 through a conventional spark plug wire 58. Contacts 42b and 42d, representing positions 2 and 4, respectively, are coupled together through spark plug wires 60a and 60b and then to second side 56 of the secondary winding 32, which side receives the negative-going output voltage of the secondary winding 32. This second side 56 is also connected to COP spark plug 16 through a conventional spark plug wire 62.

The configuration described above insures that when the rotor 40 is at positions 1 and 3, the first side 54 (e.g., a positive going side, as shown in FIG. 2) of secondary winding 32 is connected to the adjustable spark gap 46, representing the waste stroke of the cylinder associated with companion spark plug 18. When the rotor 40 is at positions 2 and 4, the second side 56 (e.g., a negative going side, as shown in FIG. 2) of secondary winding 32 is connected to the adjustable spark gap 46, representing the waste stroke of the cylinder associated with COP spark plug 16.

As illustrated, motor 26 is connected to the distributor rotor 40 to rotate the rotor synchronously with the actuator 38. Motor 26 may be a conventional DC motor powered by an appropriate power supply 71 (e.g., a 0-10V, 10A adjustable supply). Alternatively, the DC motor 26 may be powered by the same power supply 14 provided to power the primary winding 30 of the CUT 12. It bears emphasizing that the use of a motor 26 with the presently disclosed testing apparatus or simulation system 10 is not necessary. Instead, the actuator 38 and rotor 40 may be disposed on a shaft that may be manually turned (i.e., no motor) at any desired rate. In this manner, each individual ignition or spark event may be manually controlled, one event at a time. Still further, even in a testing apparatus equipped with a motor 26, the motor output shaft may itself be manually manipulated to the same effect. This low speed operation is not possible on any conventional engine-mounted testing apparatus.

To facilitate use of the secondary winding outputs of the CUT 12 in a manner which simulates the operation of a running engine, it is preferred that certain component parameters of the simulation system 10 be adjusted. For example, in the illustrated Hybrid system, the gaps of the COP spark plug 16 and the companion spark plug 18 are set at a width which causes the average breakdown voltage of the spark plug (i.e., firing line) to be in the range of about 8-12 KVp, and still more preferably about 10 KVp. The spark gap 46 is adjusted to obtain an average waste power for both the COP spark plug 16 and the companion spark plug 18 of between about 2-4 KVp, and still more preferably about 3 KVp. These parameters represent voltages that would occur in a normally operating ignition system.

To conduct the simulation, the DC motor 26 output shaft is rotated, by hand or under power, in the clockwise direction indicated by arrow 70 to rotate the rotor 40 and actuator (e.g., magnetic gear wheel) 38 connected thereto. As noted above, actuator 40 comprises, in the illustrated example, four magnets 72 located proximate inductor 36 so that, at selected degrees of rotation of the DC motor 26, output shaft, a magnet 72 position coincides not only with the inductor 36 at the same time or substantially the same time that the rotor point 44 position coincides with one of the four contacts 42a-d of distributor 22. As rotor 40 is rotated through positions 1-4, the voltage available on the first side 54 and second side 56 of the secondary winding 32 is alternately and selectively shunted to ground to simulate a waste-stroke phase for the spark plug (e.g., spark plug 18 on the first side 54 and spark plug 16 on the second side 56) associated with that shunted side. The voltage from the other one of the first side 54 and second side 56 of the secondary winding 32 is available to a respective one of the COP spark plug 16 and the companion spark plug 18 to simulate a power-stroke phase therefor. In the configuration shown in FIG. 2, the COP spark plug 16 receives the negative-going output voltage and the companion spark plug 18 receives the positive-going output voltage.

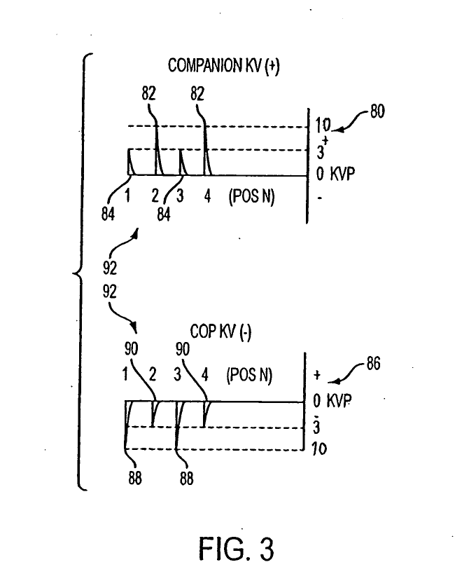

FIG. 3 generally illustrates the waste and power stroke voltages for each of the COP spark plug 16 and the companion spark plug 18. Waveform 80 shows the power stroke voltage 82 and the waste stroke voltage 84 of the companion spark plug 18. Waveform 86 shows the power stroke voltage 88 and the waste stroke voltage 90 of the COP spark plug 16. The positions or timing at which each voltage occur are indicated at 92 in each waveform. As indicated by the signal amplitudes in FIG. 3, one spark plug (e.g., 16) is in the power stroke phase while the other spark plug (e.g., 18) is in the waste stroke phase.

Accordingly, when the rotor position 40 corresponds to the contacts 42a, 42c at positions 1 and 3 of distributor 22, the COP spark plug 16 is in the power stroke phase, meaning that the voltage output by the secondary winding 32 at first side 54 is directed to ground through rotor 40. The power stroke voltage (i.e., firing line) for the COP spark plug 16 is shown at 88 in waveform 86. Since the voltage received by the COP spark plug 16 is negative going, the power stroke voltage 88 is indicated in waveform 86 as a negative voltage. Likewise, in positions 1 and 3, the companion spark plug 18 is in the waste stroke phase. Since the voltage output by the secondary winding 32 at first side 54 is directed to ground through the rotor 40 of distributor 22, the peak waste stroke voltage for the companion spark plug 18 is reduced, as shown at 84 in waveform 80. Since the voltage received by the companion spark plug 18 is positive going, the waste stroke voltage 84 is indicated in waveform 80 as a positive voltage. In this example, the peak waste stroke voltage for the companion spark plug 18 is not an actual firing line, but instead represents the rotor spark gap 46, which provides a very good approximation of the actual waste firing line.

In positions 2 and 4 of the distributor 22, the operation is switched and the voltage output by secondary winding 32 at second side 56 is directed to ground through the rotor 40 of distributor 22 to simulate a waste stroke phase for COP spark plug 16. The waste stroke voltage (i.e., spark gap 46 voltage) for the COP spark plug 16 is shown at 90 in waveform 86. Likewise, when the rotor position 40 corresponds to the contacts 42b, 42d at positions 2 and 4 of the distributor 22, the companion spark plug 18 is in the power stroke phase. The power stroke voltage for the companion spark plug 18 is shown at 82 in waveform 80.

In this example, as indicated in FIG. 3, the detected power stroke voltage for both spark plugs 16, 18 is approximately 10 KV and the detected waste stroke voltage for both spark plugs 16,18 is approximately 3 KV. Since these are the values at which the power stroke voltage and waste stroke voltage were set, it can be confirmed that the CUT 12 is operating properly. If the power stroke voltage or waste stroke voltage of either spark plug 16, 18 were significantly different from the preset values, it can be surmised that the CUT 12 is not operating properly.

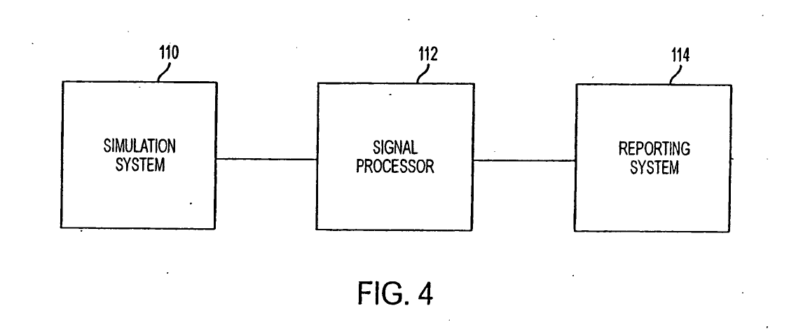

FIG. 4 illustrates a diagnostic system for testing and reporting on the voltages that are generated by the simulation system 10. As shown in FIG. 4, a testing apparatus or simulation system 110, such as described above, may be connected to one or more conventional signal processors 112 and/or amplifiers, or wave shaping circuits, to extract, filter or emphasize any particular portion of portions of the signals from the simulation system.

The output of simulation system 110 and/or signal processor 112 is provided to a reporting system 114. The reporting system 114 could include a lab scope or trace scope that displays the waveforms emanating from the simulation system 110 and associated amplifier or signal processor 112, if provided. Reporting system 114 could also provide numerical values or other representation of the data output by the simulation system 110 for some or all of the important ignition parameters, such as burn time, firing line and spark line. Further details on such analyses are set forth in U.S. Pat. No. 6,396,277, the content of which is incorporated herein by reference in its entirety. As noted above, the reporting system 114 may comprise any conventional engine analyzer, lab scope, ignition scope, or display, such as but not limited to a Snap-On® Vantage®/KV Module (EETM306A) or Snap-On® MODIS® module, commercially available from Snap-On Diagnostics in San Jose, Calif., and may further comprise a computer and local area network.

The polarity of the firing line may the same as that of the COP spark plug 16 or the companion spark plug 18. Although the simulation system 110 is described such that the COP spark plug 16 receives a negative-going voltage and the companion spark plug 18 receives a positive-going voltage, which is common for most COP ignition systems, depending upon the vehicle manufacturer, the polarity of the voltages may be reversed without affecting the operation of the simulation system as described. The voltages shown in FIG. 3 would likewise be reversed. Furthermore, although in the description, the CUT 12 is described as a hybrid ignition coil, it will be understood that a DIS coil that controls a pair of non-COP spark plugs may also be tested with the system.

The concepts described herein may be used with any desired system or engine. Those systems or engines may comprise items utilizing fossil fuels, such as gasoline, natural gas, propane and the like; non-fossil fuels, such as hydrogen or ethanol; or combinations of the above. Those systems or engines may be incorporated into other systems, such as an automobile, a truck, a boat or ship, a motorcycle, a generator, an airplane and the like.

The disclosed concepts may be practiced by employing conventional methodology and equipment. Accordingly, the details of such equipment and methodology are not set forth herein in detail. In the previous descriptions, numerous specific details are set forth, such as specific formulas, processes, techniques, etc., in order to provide a thorough understanding of the present invention. However, it should be recognized that the present invention may be practiced without resorting to the details specifically set forth.

Only an exemplary aspect of the present disclosure and but a few examples of its versatility are shown and described. It is to be understood that the present invention is capable of use in various other combinations and environments and is capable of changes or modifications within the scope of the inventive concept as expressed herein.

1. A testing apparatus for testing a waste-power ignition coil, the testing apparatus comprising:
a first power source connectable to a primary side of the waste-power ignition coil;
an ignition switch including a switching device to switch the ignition switch between
a first state, in which current flow is permitted through the primary side of the waste-power ignition coil and
a second state, in which current flow is prevented through the primary side of the waste-power ignition coil; and
a high voltage switch including a plurality of contacts, a first pair of contacts being electrically connected to a first output of the secondary side of the waste-power ignition coil, and a second pair of contacts being electrically connected to a second output of the secondary side of the waste-power ignition coil, and
a spark gap connected to the high voltage switch, wherein
the switching device acts synchronously with the high voltage switch to connect a respective one of the first output and the second output of the secondary side of the waste-power ignition coil to the spark gap to simulate a waste-stroke phase for an associated first spark plug and to provide a voltage from another of the first output and the second output of the secondary side of the waste-power ignition coil to simulate a power-stroke phase for an associated second spark plug.

2. The test apparatus according to claim 1, wherein
the high voltage switch includes a distributor with a rotor cap having the plurality of contacts and a rotor,
the rotor is directly connected to the spark gap, and
during rotation of the rotor, the rotor is directly connectable to the plurality of contacts.

3. The testing apparatus according to claim 2, further comprising an actuator disposed proximal to the switching device to switch the switching device between the first state and the second state in accord with a rotation of the actuator.

4. The testing apparatus according to claim 3, further comprising a second power source, and a motor connected to the second power source, the motor having an output shaft configured to rotate the actuator and the rotor.

5. The testing apparatus according to claim 1, wherein the spark gap is adjustable.

6. The testing apparatus according to claim 5, wherein the spark gap is adjustable to obtain an average waste power voltage of between about 2-4 KVp.

7. The testing apparatus according to claim 5, wherein the spark gap is adjustable to obtain an average waste power voltage of about 3 KVp, and a spark plug gap of each of the first spark plug and second spark plug are set to obtain an average breakdown voltage of about 10 KVp.

8. The testing apparatus according to claim 1, wherein a spark plug gap of each of the first spark plug and second spark plug is set to obtain an average breakdown voltage of between about 8-12 KVp.

9. The testing apparatus according to claim 1, wherein the first pair of contacts is electrically connected to a negative going output of the secondary coil of the waste-power ignition coil, and the second pair of opposing contacts is electrically connected to a positive going output of the secondary coil of the waste-power ignition coil.

10. A method for testing a waste-power ignition coil using a testing apparatus, the testing apparatus including a first power source connectable to a primary side of the waste-power ignition coil; an ignition switch including a switching device to switch the ignition switch between a first state, in which current flow is permitted through the primary side of the waste-power ignition coil and a second state, in which current flow is prevented through the primary side of the waste-power ignition coil; and a high voltage switch including a plurality of contacts, a first pair of contacts being electrically connected to a first output of the secondary side of the waste-power ignition coil, and a second pair of contacts being electrically connected to a second output of the secondary side of the waste-power ignition coil, and a spark gap connected to the high voltage switch, comprising the steps of:
operating the high voltage switch to intermittently, at a pre-selected interval, connect the output of the waste-power ignition coil primary coil to a spark gap;
operating the switching device to, substantially simultaneously with the operation of the high voltage switch, to connect a respective one of the first output and the second output of the secondary side of the waste-power ignition coil to the spark gap to simulate a waste-stroke phase for an associated first spark plug and to provide a voltage from another of the first output and the second output of the secondary side of the waste-power ignition coil to simulate a power-stroke phase for an associated second spark plug.
